(19) United States
(12) Patent Application Publication
(10) Pub. No.: US 2017/0174556 A1
(43) Pub. Date: Jun. 22, 2017

(54) GLASS COMPOSITION, GLASS SHEET FOR CHEMICAL STRENGTHENING, STRENGTHENED GLASS SHEET, AND STRENGTHENED GLASS SUBSTRATE FOR DISPLAY

(71) Applicant: NIPPON SHEET GLASS COMPANY, LIMITED, Tokyo (JP)

(72) Inventors: Daisuke MIYABE, Tokyo (JP); Junji KURACHI, Tokyo (JP)

(21) Appl. No.: 15/305,040

(22) PCT Filed: Mar. 12, 2015
(86) PCT No.: PCT/JP2015/001368

§ 371 Date: Oct. 18, 2016

(30) Foreign Application Priority Data
Apr. 24, 2014 (JP) 2014-090458

(51) Int. Cl. C03C 3/093; C03C 4/18; C03C 21/00; C03C 3/091

(52) U.S. Cl. CPC C03C 3/093; C03C 3/091; C03C 4/18; C03C 21/002; C03C 2204/00

(57) ABSTRACT

The glass composition of the present invention contains, in mol %: 58% or more and less than 70% SiO₂; 0 to 14% B₂O₃; 10 to 16% Al₂O₃; 0 to 12.5% MgO; 0 to 11% CaO; 0 to 3% SrO; 0 to 3% ZnO; 4.5 to 11% Li₂O; 0 to 2% Na₂O; 2 to 7% K₂O; 0 to 0.8% TiO₂; 0 to 0.5% ZrO₂; and 0 to 0.2% SnO₂. In this glass composition, the total content of Li₂O, Na₂O, and K₂O is in a range of 6.5 to 13%. The glass composition of the present invention is suitable for production by a float process and is suitable for chemical strengthening. The glass composition of the present invention has a low thermal expansion coefficient. The glass composition of the present invention has properties suitable for use in glass substrates for displays.

### TECHNICAL FIELD

The present invention relates to a glass composition. The present invention also relates to a glass sheet for chemical strengthening, a chemically-strengthened glass sheet, and a glass substrate for a display.

### BACKGROUND ART

In recent years, electronic devices with liquid crystal displays, organic EL displays, etc. and electronic devices with touch panel displays have been widespread. Glass materials intrinsically have high transparency, and their thickness can be reduced (to 0.3 mm or less) even if they are large in area (for example, 1 m² or more). Therefore, flat sheet-like glass substrates having high flatness and smoothness can be obtained relatively easily and thus are widely used as glass substrates for displays of the above-mentioned electronic devices.

Strengthening treatment of glass sheets is a well-known technique for overcoming the brittleness of glass materials. Thermal tempering and chemical strengthening are typical examples of such strengthening treatment. Glass sheets to be subjected to thermal tempering must have a certain thickness (for example, 1.4 mm or more). Therefore, chemical strengthening is the only way of strengthening such thin glass sheets as glass substrates for displays.

Chemical strengthening is typically a technique of replacing alkali metal ions contained in the glass surface by monovalent cations having a larger ionic radius so as to form a compressive stress layer in the glass surface. Chemical strengthening is performed by replacing sodium ions by potassium ions (K⁺) or replacing lithium ions (Li⁺) by sodium ions (Na⁺) or potassium ions (K⁺).

However, since glass substrates for displays are used in contact with semiconductor materials, liquid crystal materials, electroluminescent (EL) materials, etc. of the displays, it is essential that the glass substrates have no adverse effect on these display materials. For example, since semiconductor materials have low thermal expansion coefficients, the glass compositions of glass substrates for such semiconductor materials are required to have low thermal expansion coefficients (for example, an average thermal expansion coefficient of 60×10⁻⁷° C.⁻¹ or less, preferably 35 to 50×10° C.′ in the temperature range of 50 to 350° C.). In addition, since ions diffusing into semiconductor materials, liquid crystal materials, and EL materials will inhibit the functions of these materials, it is required that ions, particularly sodium ions, do not migrate from the glass substrates.

Therefore, glass sheets widely commercially available as float glass sheets meet neither the requirements of a low thermal expansion coefficient nor no migration of sodium ions, and thus alkali-free glass, for example, a glass substantially free of alkali ions as disclosed in Patent Literature 1 and Patent Literature 2, is the only conventional glass composition suitable for use in glass substrates.

It is practically impossible to subject a thin alkali-free glass sheet to strengthening treatment. Therefore, many of the electronic devices as mentioned above are provided with protective members in addition to display elements, and chemically-strengthened cover glasses containing alkali ions are often used as the protective members.

On the other hand, there have been reported various glass compositions having low thermal expansion coefficients and containing alkali ions as disclosed in Patent Literature 3 and Patent Literature 4.

The alkali ion-containing glass composition disclosed in Patent Literature 3 is a borosilicate glass containing, in weight %, 69.5 to 73.0% SiO₂, 13.0 to 15.0% B₂O₃, 4.5 to 6.0% Al₂O₃, 0.5 to 1.5% CaO, 0.5 to 2.5% BaO, 5.5 to 7.0% Na₂O, 0 to 1.5% K₂O, and 0.3 to 2.5% ZrO₂. According to Patent Literature 3, this glass composition has high chemical durability.

The alkali ion-containing glass composition disclosed in Patent Literature 4 is a glass containing, in mol %, 66 to 77% SiO₂, 7 to 17% Al₂O₃, 0 to 7% B₂O₃, 0 to 9% Li₂O, 0 to 8% Na₂O, 0 to 3% K₂O, 0 to 13% MgO, 0 to 6% CaO, 0 to 5% TiO₂, 0 to 5% ZrO₂, and in this glass composition, the total content of SiO₂, Al₂O₃, and B₂O₃ is 81 to 92%, the total content of Li₂O, Na₂O, and K₂O is 3 to 9%, the total content of MgO and CaO is 4 to 13%, the total content of Na₂O, K₂O, and CaO is 0 to 10%, and the total content of TiO₂ and ZrO₂ is 0 to 5%. According to Patent Literature 4, this glass composition has a high specific elastic modulus and a high glass transition temperature, and thus is suitable for use in substrates for information recording media.

### CITATION LIST

### Patent Literature

Patent Literature 1: JP H06(1994)-263473 A

Patent Literature 2: JP 2719504 B2

Patent Literature 3: JP H04(1992)-280833 A

Patent Literature 4: JP 2013-028512 A

### SUMMARY OF INVENTION

### Technical Problem

A working temperature and a melting temperature are known measures of the high-temperature viscosity of glass. In the float process, the working temperature is a temperature at which molten glass has a viscosity of 10⁴ dPa·s, and will hereinafter be referred to as T₄. In the present invention, the melting temperature is a temperature at which molten glass has a viscosity of 10²⁵ dPa·s, and will hereinafter be referred to as T₂₅.

The glass compositions disclosed in Patent Literature 1 and Patent Literature 2 both have low thermal expansion coefficients, but their melting temperatures are rather too high because they are substantially free of alkali ions. In addition, these glass compositions cannot be subjected to chemical strengthening treatment, as described above.

On the other hand, the glass compositions described in Patent Literature 3 and Patent Literature 4 both have low thermal expansion coefficients and contain alkali ions, but most of the alkali ions are sodium ions, which may damage semiconductor and other materials.

In view of the above circumstances, it is an object of the present invention to provide a glass composition capable of being subjected to sufficient chemical strengthening treatment in spite of its low thermal expansion coefficient, and particularly to provide a glass composition having properties suitable for production by a float process and capable of being formed into a thin glass sheet having high flatness and smoothness.

### Solution to Problem

In order to achieve the above object, the present invention provides a glass composition containing, in mol %:

58% or more and less than 70% SiO₂;

0 to 14% B₂O₃;

10 to 16% Al₂O₃;

0 to 12.5% MgO;

0 to 11% CaO;

0 to 3% SrO;

0 to 3% ZnO;

4.5 to 11% Li₂O;

0 to 2% Na₂O;

2 to 7% K₂O;

0 to 0.8% TiO₂;

0 to 0.5% ZrO₂; and

0 to 0.2% SnO₂, wherein

a total content of Li₂O, Na₂O, and K₂O is in a range of 6.5 to 13%.

In another aspect, the present invention provides a glass sheet for chemical strengthening, having the above-mentioned glass composition, wherein the glass sheet is a glass sheet produced by a float process and used in chemical strengthening treatment.

In still another aspect, the present invention provides a strengthened glass sheet having a compressive stress layer formed as a surface of the strengthened glass sheet by bringing the above-mentioned glass sheet having the above-mentioned glass composition into contact with a molten salt containing monovalent cations having an ionic radius larger than that of sodium ions so as to cause ion exchange in which lithium ions and/or sodium ions contained in the above-mentioned glass composition are replaced by the monovalent cations.

In yet still another aspect, the present invention provides a glass substrate for a display, the glass substrate including the above-mentioned strengthened glass sheet.

### Advantageous Effects of Invention

In the glass composition according to the present invention, the total content of alkali metal oxides (Li₂O, Na₂O, and K₂O) is appropriately limited. Therefore, glass articles having the glass composition according to the present invention are suitable for use in applications that require not only a thermal expansion coefficient of 60×10⁻⁷° C.⁻¹ or less but also capability of being chemically strengthened. Furthermore, in the glass composition according to the present invention, the liquidus temperature T_{L} and the difference T₄−T_{L} obtained by subtracting the liquidus temperature T_{L} from the working temperature T₄ satisfy the conditions suitable for the float process. Therefore, the float process can be used as a method for mass production of glass substrates.

### DESCRIPTION OF EMBODIMENTS

Hereinafter, the percentages of the components of the glass composition are all expressed in mol %, unless otherwise specified. In this description, the phrase “consisting essentially of components” means that the total content of the components referred to is 99.5 mass % or more, preferably 99.9 mass % or more, and more preferably 99.95 mass % or more. The phrase “being substantially free of a component” means that the content of the component is 0.1 mass % or less, and preferably 0.05 mass % or less.

Using an alkali aluminosilicate glass as a glass matrix composition to minimize the total content of alkali metal oxides having a positive correlation with the thermal expansion coefficient and to provide sufficient capability of being chemically strengthened, the inventors of the present invention have studied the contents of alkali metal oxides, alkaline earth metal oxides, and others. As a result, they have succeeded in finding a glass composition capable of providing a compressive stress layer with both an exceptionally large value of surface compressive stress (>550 MPa) and a great depth (>25 μm) and thus completed the present invention.

Hereinafter, the components of the glass composition of the present invention are described.

(SiO₂)

SiO₂ is an oxide that forms the main glass network and an essential main component of the glass composition. A too low content of SiO₂ results in a too high thermal expansion coefficient of the glass composition, and in a decrease in the chemical durability such as water resistance and the heat resistance of the glass. On the other hand, a too high content of SiO₂ results in an increase in the high-temperature viscosity and liquidus temperature T_{L} of the glass composition, which makes it difficult to melt and form the glass composition. Therefore, the content of SiO₂ needs to be 58 mol % or more and less than 70 mol %. The content of SiO₂ is preferably 60 to 69 mol %, and more preferably 63 to 67 mol %.

(Al₂O₃)

Al₂O₃ is an essential component that improves the chemical durability such as water resistance of the glass composition and further facilitates migration of alkali metal ions in the glass and thus increases the surface compressive stress and the depth of the compressive stress layer of the chemically strengthened glass. On the other hand, a too high content of Al₂O₃ increases the viscosity of the glass melt, and thus increases the T_{2.5} and T₄ and reduces the clarity of the glass melt, which makes it difficult to produce a high quality glass sheet. The liquidus temperature T_{L} also is increased.

Therefore, the appropriate content of Al₂O₃ is in a range of 10 to 16 mol %. The content of Al₂O₃ is preferably 10 to 15 mol %, and more preferably 12 to 15 mol %.

(B₂O₃)

B₂O₃ is an optional component. However, it is preferable that the glass composition contain B₂O₃ because B₂O₃ reduces the viscosity of the glass melt without rapidly increasing the thermal expansion coefficient so as to improve the meltability of the glass composition and effectively reduces the liquidus temperature T_{L} up to a predetermined threshold for the content of B₂O₃. On the other hand, a too high content of B₂O₃ increases the liquidus temperature T_{L}, increases the thermal expansion coefficient, and makes the glass composition more susceptible to phase separation.

Therefore, the content of B₂O₃ needs to be 14 mol % or less. The content of B₂O₃ is preferably 0.1 mol % or more, more preferably 2 to 8 mol %, even more preferably 3 to 6 mol %, and still even more preferably 4 to 5 mol %.

(Li₂O)

Li₂O is an essential component for providing a compressive stress layer as the surface of a glass article by ion exchange in which lithium and/or sodium ions in the glass are replaced by monovalent cations having an ionic radius larger than that of sodium ions. Li₂O also has the effect of reducing the viscosity of the glass melt so as to improve the meltability. There is a positive correlation between the content of alkali metal oxides and the thermal expansion coefficient. Li₂O is the least effective of all alkali metal oxides in increasing the thermal expansion coefficient. On the other hand, a too high content of Li₂O increases the thermal expansion coefficient, resulting in a too high liquidus temperature T_{L}.

Therefore, the content of Li₂O needs to be 4.5 to 11 mol %. The content of Li₂O is preferably 5 to 8 mol %.

(K₂O)

K₂O is an essential component that can significantly increase the depth of a compressive stress layer formed by the above-mentioned ion exchange when used in combination with Li₂O. On the other hand, K₂O is more effective in increasing the thermal expansion coefficient than Li₂O and Na₂O. Therefore, a too high content of K₂O increases the thermal expansion coefficient too much.

Therefore, the content of K₂O needs to be 2 to 7 mol %. The content of K₂O is preferably 4 mol % or less, more preferably 3.5 mol % or less, and even more preferably 3 mol % or less.

(Na₂O)

Na₂O is a component having the effect of reducing the viscosity of the glass melt so as to improve the meltability, but is an optional component. Unlike K₂O, Na₂O is ineffective in increasing the depth of a compressive stress layer. Na₂O is more effective in increasing the thermal expansion coefficient than Li₂O.

Therefore, the content of Na₂O needs to be 2 mol % or less. Preferably, the glass composition is substantially free of Na₂O. The glass composition substantially free of Na₂O is suitable for use in avoiding migration of sodium ions from the glass.

(R₂O)

In the present invention, R₂O collectively refers to Li₂O, Na₂O, and K₂O. If the content of R₂O is too low, the amount of the components that reduce the viscosity of the glass composition is too small, which makes it difficult to melt the glass composition. On the other hand, if the content of R₂O is too high, the thermal expansion coefficient increases too much.

Therefore, the appropriate content of R₂O is in a range of 6.5 to 13 mol %. The content of R₂O is preferably 7 to 11 mol %, and more preferably 8 to 10 mol %.

(MgO)

MgO is an optional component. However, it is preferable that the glass composition contain MgO because MgO has the effect of reducing the viscosity of the glass melt so as to improve the meltability and increasing the compressive stress to be applied to the surface of a glass article by the above-mentioned ion exchange. On the other hand, a too high content of MgO increases the liquidus temperature T_{L} and increases the thermal expansion coefficient too much.

Therefore, in the glass composition of the present invention, the content of MgO needs to be 12.5 mol % or less. The content of MgO is preferably 1.5 to 11.5 mol %, more preferably 3 to 9 mol %, and even more preferably 4 to 8.5 mol %.

(CaO)

CaO is an optional component. However, it is preferable that the glass composition contain CaO because CaO has the effect of reducing the liquidus temperature T_{L} and increasing the surface compressive stress produced by the above-mentioned ion exchange up to a predetermined threshold for the content of CaO. On the other hand, CaO is more effective in increasing the thermal expansion coefficient and reducing the depth of the compressive stress layer than MgO.

Therefore, the appropriate content of CaO is 11 mol % or less. The content of CaO is preferably 6 mol % or less, more preferably 0.5 to 2 mol %, and even more preferably 0.5 to 1.5 mol %.

(SrO)

SrO is an optional component that can reduce the liquidus temperature T_{L}. However, SrO is more effective in increasing the thermal expansion coefficient than MgO. In addition, SrO significantly inhibits the above-mentioned ion exchange and thus significantly reduces the depth of the compressive stress layer.

Therefore, in the glass composition of the present invention, the content of SrO needs to be 3 mol % or less. The content of SrO is preferably 2.5 mol % or less, and more preferably the glass composition is substantially free of SrO.

(BaO)

BaO significantly inhibits the above-mentioned ion exchange and thus significantly reduces the depth of the compressive stress layer. Therefore, the glass composition of the present invention is substantially free of BaO.

(ZnO)

ZnO is an optional component having the effect of reducing the liquidus temperature T_{L} without increasing the thermal expansion coefficient, if its content is low. On the other hand, if the content of ZnO is higher than a predetermined range, the liquidus temperature T_{L} is increased too much and the depth of the compressive stress layer formed by the above-mentioned ion exchange is significantly reduced.

Therefore, the content of ZnO needs to be 3 mol % or less. The content of ZnO is preferably 2.5 mol % or less, and more preferably the glass composition is substantially free of ZnO.

(TiO)

TiO₂ is an optional component, and if its content is within a predetermined low range, it has the effect of increasing the surface compressive stress by the above-mentioned ion exchange. However, TiO₂ may color the glass composition yellow. If its content is higher than a predetermined range, the depth of the compressive stress layer is reduced. Therefore, the content of TiO₂ needs to be 0.8 mol % or less. Preferably, the content of TiO₂ is 0.15 mol % or less. There may be a case where TiO₂ is inevitably contained in the glass composition due to an industrial raw material and the glass composition contains about 0.03 mass % TiO₂. Even such a low content of TiO₂ has the effect of increasing the surface compressive stress but does not cause coloring. Therefore, the glass composition of the present invention may contain TiO₂ if its content is low.

(ZrO₂)

ZrO₂ is a component that can reduce the thermal expansion coefficient and improve the water resistance of the glass. However, if the content of ZrO₂ is higher than a predetermined relatively low range, the liquidus temperature T_{L} tends to increase rapidly. Therefore, the content of ZrO₂ needs to be 0.5 mol % or less. Preferably, the content of ZrO₂ is 0.15 mol % or less, and more preferably the glass composition is substantially free of ZrO₂. On the other hand, it is known that, particularly when a glass sheet is produced by the float process, ZrO₂ derived from refractory bricks of the glass melting furnace may be mixed in the glass composition and contained in an amount of about 0.01 mass %. Such a low content of ZrO₂ has little effect on the liquidus temperature T_{L} and does not cause coloring. Therefore, the glass composition of the present invention may contain ZrO₂ if its content is low.

(SnO₂)

It is known that, in formation of a glass sheet by the float process, molten tin in a tin bath diffuses into the surface of the glass sheet in contact with the tin bath so as to be present in the form of SnO₂. SnO₂ also contributes to degassing of molten glass when it is mixed as one of the glass raw materials. However, a glass composition containing SnO₂ tends to be phase-separated. In the glass composition of the present invention, the content of SnO₂ is preferably 0 to 0.2 mol %, more preferably 0.1 mol % or less, and even more preferably the glass composition is substantially free of SnO₂. It should be noted that the glass sheet formed by the float process contains 0.005 to 0.02 mass % SnO₂ due to the use of glass cullet, when calculated on the basis of the glass composition. Glass cullet, which includes end and edge portions of a glass ribbon separated from a glass product in the glass production process, is commonly used as a recycled component of the glass material in a plant. However, such a low content of SnO₂ does not cause phase separation of the glass composition.

(Fe₂O₃)

Fe is normally present in the form of Fe²⁺ or Fe³⁺ in glass, and acts as a colorant. Fe³⁺ is a component that improves the ultraviolet ray absorbing properties of glass, and Fe²⁺ is a component that improves the heat ray absorbing properties of glass. However, when the glass composition is used for a cover glass of a display, it is preferable to minimize the content of Fe to prevent the glass composition from being conspicuously colored. However, when the glass composition contains a small amount of Fe, the clarity of the resulting molten glass is improved. Fe is often inevitably contained in the glass composition due to an industrial raw material. For these reasons, the total content of iron oxides as calculated in terms of Fe₂O₃ content (i.e., the total iron oxide content T-Fe₂O₃ in terms of Fe₂O₃) can be 0.2 mass % or less with respect to 100 mass % of the glass composition.

(Other Components)

Preferably, the glass composition of the present invention consists essentially of the components sequentially described above. The glass composition of the present invention may contain components other than the components sequentially described above. In this case, the content of each of the other components is preferably less than 0.1 mass %.

Examples of the other components that the glass composition may contain include SO₃, As₂O₅, Sb₂O₅, CeO₂, Cl, and F in addition to the above-mentioned SnO₂. These components are added to degas the molten glass. When SO₃ is derived from sodium sulfate, the glass composition inevitably contains Na₂O. It is preferable not to add As₂O₅, Sb₂O₅, Cl, and F for reasons such as their serious adverse effects on the environment.

Other examples of the components that the glass composition may contain include ZnO, P₂O₅, GeO₂, Ga₂O₃, Y₂O₃, and La₂O₃. The glass composition may contain components other than the above-mentioned components derived from industrially available raw materials, unless the content of each of these components exceeds 0.1 mass %. Since these components are optionally added if necessary or are inevitably contained, the glass composition of the present invention may be substantially free of these components.

Hereinafter, the properties of the glass composition of the present invention are described.

(Melting Temperature: T_{2.5})

When the temperature (melting temperature: T₂₅) at which the molten glass has a viscosity of 10²⁵ dPa·s is low, the amount of energy required to melt the glass raw materials can be reduced, and the glass raw materials can be more easily melted to promote degassing and refining of the glass melt. According to the present invention, for example, it is possible to reduce the T_{2.5} to 1550° C. or lower, even 1530° C. or lower, and optionally to 1500° C. or lower.

(Working Temperature: T₄)

In the float process, the viscosity of molten glass is adjusted to about 10⁴ dPa·s (10⁴P (poise)) when the molten glass in a melting furnace is poured into a float bath. In the production by the float process, it is preferable that the temperature (working temperature: T₄) at which the molten glass has a viscosity of 10⁴ dPa·s be lower. For example, in order to form the glass into a thin sheet for use as a cover glass of a display, the working temperature T₄ of the molten glass is preferably 1300° C. or lower. According to the present invention, it is possible to provide a glass composition having a T₄ of 1270° C. or lower, even 1250° C. or lower, and optionally 1200° C. or lower and thus suitable for production by the float process. The lower limit of the T₄ is not particularly limited, and it is 1000° C., for example.

(Difference between Working Temperature and Liquidus Temperature: T₄−T_{L})

In the float process, it is preferable that molten glass does not devitrify when the temperature of the molten glass is T₄. In other words, it is preferable that the difference between the working temperature (T₄) and the liquidus temperature (T_{L}) be large. According to the present invention, it is possible to provide a glass composition in which a difference obtained by subtracting the liquidus temperature from the working temperature is as large as −10° C. or more, and even 0° C. or more.

(Liquidus Temperature: T_{L})

In the glass composition of the present invention, not only the above-mentioned difference T₄−T_{L} but also the liquidus temperature (T_{L}) can be used as a measure of the ease of production by the float process. According to the present invention, it is possible to provide a glass composition having a T_{L} of 1200° C. or lower, and even 1195° C. or lower.

(Glass Transition Temperature: Tg)

According to the present invention, it is possible to provide a glass composition having a glass transition temperature (Tg) of 580 to 655° C., and thus it is easier to slowly cool molten glass to produce the glass composition in which the surface compressive stress generated by ion exchange is less likely to relax.

(Density (Specific Gravity): d)

It is desirable that a glass substrate used for a display of an electronic device have a low density to reduce the weight of the electronic device. According to the present invention, it is possible to reduce the density of the glass composition to 2.50 g·cm⁻³ or less, and even 2.45 g·cm⁻³ or less.

(Elastic Modulus: E) When a glass substrate is subjected to chemical strengthening involving ion exchange, the glass substrate may be warped. It is preferable that the glass composition have a high elastic modulus to reduce this warpage. According to the present invention, it is possible to increase the elastic modules (Young's modulus: E) of the glass composition to 75 GPa or more, and even to 80 GPa or more.

The chemical strengthening of the glass composition is described below.

(Conditions of Chemical Strengthening and Compressive Stress Layer)

Chemical strengthening of the glass composition according to the present invention can be performed by bringing the glass composition containing a lithium compound and/or a sodium compound into contact with a molten salt containing monovalent cations, preferably potassium ions, having an ionic radius larger than that of sodium ions, so as to cause ion exchange in which lithium ions and/or sodium ions in the glass composition are replaced by the monovalent cations. Thus, a compressive stress layer having a compressive stress is formed as the surface of the resulting glass article.

A typical example of the molten salt is potassium nitrate. A molten salt mixture of potassium nitrate and sodium nitrate also can be used, but it is preferable to use potassium nitrate alone because it is difficult to control the concentration of a molten salt mixture.

The surface compressive stress and the depth of the compressive stress layer of a strengthened glass article can be controlled not only by the glass composition of the article but also by the temperature of the molten salt and the treatment time in the ion exchange treatment.

It is possible to obtain a strengthened glass article having a compressive stress layer with a very high surface compressive stress and a very great depth by bringing the glass composition of the present invention into contact with a molten salt of potassium nitrate. Specifically, it is possible to obtain a strengthened glass article having a compressive stress layer with a surface compressive stress of 550 MPa or more and a depth of 25 μm or more. It is also possible to obtain a strengthened glass article having a compressive stress layer with a depth of 30 μm or more and a surface compressive stress of 600 MPa or more.

Since this strengthened glass article of the present invention has a very high surface compressive stress, its surface is resistant to scratching. In addition, since the strengthened glass article has a compressive stress layer with a very great depth, even if the surface has a scratch, the scratch is less likely to develop into the glass article due to the presence of the compressive stress layer and thus is less likely to damage the strengthened glass article. Thus, this strengthened glass article of the present invention has a strength suitable for use as a cover glass of a display, for example.

According to the present invention, it is possible to provide a glass composition having a relatively low T₄, suitable for production by the float process, and advantageous in forming glass into a thin glass sheet for use as a cover glass of a display.

The strengthened glass article obtained by chemically strengthening the glass composition of the present invention is suitable for use as a glass substrate of a liquid crystal display, an organic EL display, a touch-panel display, or the like for an electronic device. The strengthened glass article can also be used as a cover glass of such a display.

### EXAMPLES

Hereinafter, the present invention will be described in more detail by way of Examples and Comparative Examples. It should be noted that Examples given below are only illustrative of the present invention and do not limit the present invention.

(Preparation of Glass Composition)

Glass samples of Examples 1 to 43 and Comparative Examples 1 to 12 were obtained in the following manner. Commonly available glass raw materials such as silica, boron oxide, alumina, magnesium oxide, calcium carbonate, strontium carbonate, barium carbonate, zinc oxide, lithium carbonate, sodium carbonate, potassium carbonate, titanium oxide, zirconium oxide, tin oxide, and iron oxide were used to prepare glass formulations (batches) having the glass compositions shown in Tables 1 to 5. The batches thus prepared were each put into a platinum crucible and heated in an electric furnace at 1550° C. for 1.5 hours and then further heated at 1640° C. for 4 hours. Thus, a molten glass was obtained. Next, the molten glass was poured on an iron plate for cooling to obtain a glass plate. Next, this glass plate was again placed in the electric furnace and held at 720° C. for 1 hour. Then, the furnace was turned off to slowly cool the glass plate to room temperature. Thus, a glass sample was obtained.

For each of the glass samples of some or all of Examples and Comparative Examples, the glass transition temperature Tg, the thermal expansion coefficient α, the working temperature T₄, the melting temperature T_{2.5}, the liquidus temperature T_{L}, the density d, and the Young's modulus E were measured.

The glass transition temperature Tg was measured using a differential thermal analyzer (Thermo Plus TMA 8310 manufactured by Rigaku Corporation). The average linear thermal expansion coefficient was measured using the same differential thermal analyzer at 50 to 350° C. and used as the thermal expansion coefficient α. The working temperature T₄ and the melting temperature T_{2.5} were measured by a platinum ball pulling-up method. The density d was measured by an Archimedes method. The Young's modulus E was measured according to JIS (Japanese Industrial Standards) R 1602-1995, 5.3 “ultrasonic pulse echo method”. For measurement of the Young's modulus, the frequency of the ultrasonic wave was set at 20 kHz, and test samples of 25 mm×35 mm×5 mm were used.

The liquidus temperature T_{L} was measured in the following manner. The glass sample was pulverized and sieved. Glass particles that passed through a 2.8-mm mesh sieve but retained on a 1.1-mm mesh sieve were obtained. These glass particles were immersed in ethanol and subjected to ultrasonic cleaning, followed by drying in a thermostat. 25 g of the glass particles were spread to an approximately uniform thickness in a platinum boat having a width of 12 mm, a length of 200 mm, and a depth of 10 mm so as to obtain a measurement sample in this form. This platinum boat was placed in an electric furnace (a temperature gradient furnace) with a temperature gradient from about 850 to 1210° C. for 2 hours. Then, the measurement sample was observed using an optical microscope with a magnification of 100, and the highest temperature in a region where devitrification was observed was determined to be the liquidus temperature of the sample. In all Examples and Comparative Examples, the glass particles in the measurement samples were fused together to form rods in the temperature gradient furnace.

(Preparation of Strengthened Glass)

The glass sample thus obtained was cut into pieces of 25 mm×35 mm. Both surfaces of each piece were polished with alumina abrasive grains and further mirror-polished with cerium oxide abrasive grains. Thus, four 1.1-mm-thick glass sheets both surfaces of which had a surface roughness Ra (Ra determined according to JIS B 0601-1994) of 2 nm or less were obtained for each composition (for each Example or Comparative Example).

These glass sheets were immersed in a potassium nitrate molten salt (with a purity of not less than 99.5 mass %) having a predetermined temperature of 480° C. for a predetermined time of 16 hours so as to chemically strengthen the glass sheets. Only in Comparative Example 12 having a low Tg of 565° C., the glass sheets were immersed in a potassium nitrate molten salt having a temperature of 430° C. After the chemical strengthening treatment, the glass sheets were washed with hot water at 80° C. Thus, strengthened glass sheets of Examples and Comparative Examples were obtained.

In order to reduce the thermal shock applied to the glass sheets, they were preheated before being immersed in the molten salt and were slowly cooled after being immersed in the molten salt (that is, after being removed from the molten salt bath). Preheating was performed by a process in which the glass sheets were held for 10 minutes in a space within the molten salt container and above the liquid level of the molten salt. Slow cooling was also performed by the same process as preheating. This slow cooling process also has the effect of returning to the molten salt container as much as possible of the molten salt remaining on the glass sheets removed from the molten salt bath.

For the strengthened glass sheets thus obtained, the surface compressive stress and the compression depth (the depth of the compressive stress layer) were measured using a surface stress meter “FSM-6000LE” manufactured by Orihara Industrial Co., Ltd. Tables 1 to 5 collectively show the results. In Table 5, “N/A” means that the data was not available because no interference fringes were observed and thus the compressive stress and the compression depth could not be measured.

In all Examples, glass samples having a thermal expansion coefficient α of 60×10⁻⁷° C.⁻¹ or less and strengthened glass articles having a compressive stress layer with a high surface compressive stress (550 MPa or more) and a great depth (25 μm or more) were successfully obtained. In some Examples, glass samples having a thermal expansion coefficient α of 50×10⁻⁷° C.⁻¹ or less and strengthened glass articles having a compressive stress layer with a surface compressive stress of 600 MPa or more, 700 MPa or more, or even 750 MPa or more, and with a depth of 30 μm or more or even 40 μm or more were obtained. This result shows that the glass composition of the present invention and a glass sheet obtained by chemically strengthening the glass composition are suitable for use in glass substrates for displays that require substrates with a low thermal expansion coefficient and high strength.

In all Examples, the liquidus temperatures T_{L} were 1200° C. or lower and 1195° C. or lower. In all Examples measured, the differences T₄−T_{L} each obtained by subtracting the liquidus temperature T_{L} from the working temperature T₄ were 0° C. or more. Thus, the glass composition of the present invention is suitable for production of glass sheets by the float process.

In all Examples measured, the working temperatures T₄ were 1300° C. or lower and the melting temperatures T_{2.5} were 1580° C. or lower. This result shows that the glass compositions obtained in Examples can be sufficiently refined and high quality glass sheets can be produced from the glass compositions by the float process in conventional float glass production facilities. In addition, the glass transition temperatures Tg were within the range of 580 to 655° C. This result shows that the glass compositions obtained in Examples can be suitably used in applications that require higher heat resistance than that of conventional glass sheets produced by the float process, for example, in substrates for CIS thin film solar cells and CIGS thin film solar cells. Furthermore, in some Examples, the densities were 2.45 g·cm⁻³ or less and the Young's moduli as the elastic moduli were 80 GPa or more. This result shows that, in combination with the characteristics of a low thermal expansion coefficient and capability of being subjected to chemical strengthening, strengthened glass obtained from the glass composition of the present invention can also be suitably used in substrates for high density recording magnetic disks.

By contrast, in Comparative Example 12, even though the glass composition having a too low Al₂O₃ content was chemically strengthened, the surface compressive stress and depth of the resulting compressive stress layer were less than 550 MPa and less than 25 μm, respectively. This result shows that Comparative Example 12 was not suitable for obtaining an appropriate strengthened glass.

Comparative Example 9 corresponding to Example 21 of Patent Literature 4 was not suitable for production by the float process because the glass composition of Comparative Example 9 had a too high Al₂O₃ content and thus had a liquidus temperature of higher than 1210° C. In addition, even though the glass composition of Comparative Example 9 was chemically strengthened, the surface compressive stress and depth of the resulting compressive stress layer were less than 550 MPa and less than 25 μm, respectively. This result shows that Comparative Example 9 was not suitable for obtaining an appropriate glass composition.

It cannot be said that Comparative Example 8 was suitable for production by the float process because the glass composition of Comparative Example 8 had a too high ZnO content and thus had a liquidus temperature of higher than 1210° C.

In Comparative Example 10 (corresponding to Example 26 of Patent Literature 4) and Comparative Example 11, even though the glass compositions each having a too low Li₂O content were chemically strengthened, the surface compressive stress of the resulting compressive stress layer was less than 550 MPa. This result shows that Comparative Example 10 and 11 were not suitable for obtaining an appropriate strengthened glass.

On the other hand, in Comparative Example 6, the glass composition having a too high Li₂O content had a thermal expansion coefficient of more than 60×10⁻⁷° C.⁻¹, and thus was not suitable for obtaining a glass composition having an appropriate thermal expansion coefficient. In addition, the glass composition of Comparative Example 6 had a liquidus temperature T_{L} of higher than 1210° C., and thus was not suitable for production by the float process.

In Comparative Example 2, even though the glass composition having a too high Na₂O content was chemically strengthened, the depth of the resulting compressive stress layer was less than 25 μm. This result shows that Comparative Example 2 was not suitable for obtaining an appropriate strengthened glass.

In Comparative Examples 1, 2, and 12, even though the glass compositions each having a too low K₂O content were chemically strengthened, the depth of the resulting compressive stress layer was less than 25 μm. This result shows that Comparative Examples 1, 2, and 12 were not suitable for obtaining an appropriate strengthened glass.

In Comparative Example 3, even though the glass composition having a too high TiO₂ content was chemically strengthened, the depth of the resulting compressive stress layer was less than 25 μm. This result shows that Comparative Example 3 was not suitable for obtaining an appropriate glass composition.

In Comparative Examples 4 and 5, the glass compositions each had a too high ZrO₂ content, and thus had a liquidus temperature of higher than 1210° C. This result shows that Comparative Examples 4 and 5 were not suitable for production by the float process.

TABLE 1

| | | Examples | | | | | | | | | | | |
|---|---|---|---|---|---|---|---|---|---|---|---|---|---|
| | | 1 | 2 | 3 | 4 | 5 | 6 | 7 | 8 | 9 | 10 | 11 | 12 |
| Composition | SiO₂ | 64.1 | 64.1 | 63.8 | 66.8 | 63.8 | 63.7 | 64.1 | 64.0 | 64.1 | 63.3 | 64.6 | 64.6 |
| [mol %] | B₂O₃ | 4.67 | 2.33 | 4.70 | 4.70 | 4.70 | 4.70 | 4.67 | 4.70 | 2.33 | 4.70 | 4.70 | 4.70 |
| | Al₂O₃ | 12.58 | 12.58 | 13.60 | 13.60 | 13.60 | 14.10 | 12.58 | 13.10 | 12.58 | 14.60 | 12.60 | 12.60 |
| | MgO | 7.33 | 8.79 | 7.30 | 4.30 | 8.30 | 7.30 | 8.79 | 7.30 | 11.12 | 7.30 | 7.30 | 6.80 |
| | CaO | 1.46 | 0 | 1.50 | 1.50 | 0.50 | 1.50 | 0 | 1.50 | 0 | 1.50 | 1.50 | 1.50 |
| | SrO | 0 | 0 | 0 | 0 | 0 | 0 | 0 | 0 | 0 | 0 | 0 | 0 |
| | BaO | 0 | 0 | 0 | 0 | 0 | 0 | 0 | 0 | 0 | 0 | 0 | 0 |
| | ZnO | 0 | 2.34 | 0 | 0 | 0 | 0 | 0 | 0 | 0 | 0 | 0 | 0 |
| | Li₂O | 7.20 | 7.20 | 6.20 | 6.20 | 6.20 | 5.70 | 7.20 | 6.70 | 7.20 | 5.20 | 6.70 | 7.20 |
| | Na₂O | 0 | 0 | 0 | 0 | 0 | 0 | 0 | 0 | 0 | 0 | 0 | 0 |
| | K₂O | 2.53 | 2.53 | 2.80 | 2.80 | 2.80 | 2.90 | 2.53 | 2.65 | 2.53 | 3.30 | 2.50 | 2.50 |
| | TiO₂ | 0 | 0 | 0 | 0 | 0 | 0 | 0 | 0 | 0 | 0 | 0 | 0 |
| | ZrO₂ | 0 | 0 | 0 | 0 | 0 | 0 | 0 | 0 | 0 | 0 | 0 | 0 |
| | SnO₂ | 0.05 | 0.10 | 0 | 0 | 0.10 | 0.10 | 0.10 | 0 | 0 | 0.10 | 0.10 | 0 |

| | | | | | | | | | | | | |
|---|---|---|---|---|---|---|---|---|---|---|---|---|
| T-Fe₂O₃ [mass %] | 0.10 | 0.01 | 0.20 | 0.10 | 0.02 | 0.01 | 0.01 | 0.10 | 0.20 | 0.02 | 0.01 | 0.10 |
| R₂O [mol %] | 9.73 | 9.73 | 9.00 | 9.00 | 9.00 | 8.60 | 9.73 | 9.35 | 9.73 | 8.50 | 9.20 | 9.70 |
| RO [mol %] | 8.79 | 11.13 | 8.80 | 5.80 | 8.80 | 8.80 | 8.79 | 8.80 | 11.12 | 8.80 | 8.80 | 8.30 |
| Thermal expansion | 50 | 50 | 50 | 50 | 48 | 50 | 52 | 55 | 53 | 53 | 52 | 53 |
| coefficient α | | | | | | | | | | | | |
| [×10⁻⁷° C.⁻¹] | | | | | | | | | | | | |
| Glass transition | 628 | 595 | 629 | 639 | 634 | 622 | 610 | 622 | 603 | 641 | 618 | 613 |
| temperature Tg [° C.] | | | | | | | | | | | | |
| Liquidus temperature | 1181 | 1172 | 1165 | 1184 | 1163 | 1160 | 1190 | 1173 | 1177 | 1136 | 1171 | 1178 |
| T_{L} [° C.] | | | | | | | | | | | | |
| Surface compressive | 791 | 638 | 645 | 620 | 609 | 612 | 644 | 648 | 630 | 604 | 653 | 653 |
| stress CS [MPa] | | | | | | | | | | | | |
| Depth of compressive | 33 | 31 | 32 | 40 | 33 | 32 | 33 | 32 | 31 | 33 | 31 | 32 |
| stress layer DOL [μm] | | | | | | | | | | | | |
| T₄ − T_{L} [° C.] | 13 | | 50 | 78 | | | 5 | | | | | |
| Melting temperature | 1490 | | 1505 | 1562 | | | 1494 | | | | | |
| T_{2.5} [° C.] | | | | | | | | | | | | |
| Working temperature | 1194 | | 1215 | 1262 | | | 1195 | | | | | |
| T₄ [° C.] | | | | | | | | | | | | |
| T_{4.5} [° C.] | 1122 | | 1145 | 1188 | | | 1125 | | | | | |
| Density (specific | 2.410 | | 2.410 | | | 2.410 | 2.400 | 2.410 | | | | |
| gravity) d | | | | | | | | | | | | |
| [g · cm⁻³] | | | | | | | | | | | | |
| Young's modulus | | | 81 | | | 81 | 81 | 81 | | | | |
| E [GPa] | | | | | | | | | | | | |

TABLE 2

| | | Examples | | | | | | | | | | | |
|---|---|---|---|---|---|---|---|---|---|---|---|---|---|
| | | 13 | 14 | 15 | 16 | 17 | 18 | 19 | 20 | 21 | 22 | 23 | 24 |
| Composition | SiO₂ | 64.8 | 63.6 | 64.8 | 65.8 | 65.8 | 63.5 | 64.1 | 64.1 | 62.9 | 62.9 | 64.1 | 64.1 |
| [mol %] | B₂O₃ | 3.70 | 4.70 | 4.70 | 4.70 | 4.70 | 4.70 | 2.33 | 2.33 | 4.58 | 4.58 | 4.67 | 4.70 |
| | Al₂O₃ | 13.60 | 12.60 | 13.60 | 13.60 | 13.60 | 14.60 | 12.58 | 12.58 | 12.34 | 12.34 | 12.58 | 14.60 |
| | MgO | 7.30 | 7.80 | 6.30 | 5.30 | 1.50 | 7.30 | 8.79 | 8.79 | 10.5 | 8.62 | 5.87 | 6.80 |
| | CaO | 1.50 | 2.50 | 1.50 | 1.50 | 5.30 | 1.50 | 2.34 | 0 | 0 | 1.91 | 2.92 | 1.50 |
| | SrO | 0 | 0 | 0 | 0 | 0 | 0 | 0 | 2.34 | 0 | 0 | 0 | 0 |
| | BaO | 0 | 0 | 0 | 0 | 0 | 0 | 0 | 0 | 0 | 0 | 0 | 0 |
| | ZnO | 0 | 0 | 0 | 0 | 0 | 0 | 0 | 0 | 0 | 0 | 0 | 0 |
| | Li₂O | 6.20 | 5.70 | 6.20 | 6.20 | 6.20 | 5.20 | 7.20 | 7.20 | 7.06 | 7.06 | 7.20 | 5.20 |
| | Na₂O | 0 | 0 | 0 | 0 | 0 | 0 | 0 | 0 | 0 | 0 | 0 | 0 |
| | K₂O | 2.80 | 3.00 | 2.80 | 2.80 | 2.80 | 3.10 | 2.53 | 2.53 | 2.48 | 2.48 | 2.53 | 3.00 |
| | TiO₂ | 0 | 0 | 0 | 0 | 0 | 0 | 0 | 0 | 0 | 0 | 0 | 0 |
| | ZrO₂ | 0 | 0 | 0 | 0 | 0 | 0 | 0 | 0 | 0 | 0 | 0 | 0 |
| | SnO₂ | 0.05 | 0.10 | 0.10 | 0 | 0.10 | 0.10 | 0 | 0 | 0.10 | 0.10 | 0.05 | 0.10 |

| | | | | | | | | | | | | |
|---|---|---|---|---|---|---|---|---|---|---|---|---|
| T-Fe₂O₃ [mass %] | 0.02 | 0.01 | 0.01 | 0.10 | 0.01 | 0.01 | 0.20 | 0.20 | 0.01 | 0.01 | 0.02 | 0.01 |
| R₂O [mol %] | 9.00 | 8.70 | 9.00 | 9.00 | 9.00 | 8.30 | 9.73 | 9.73 | 9.54 | 9.54 | 9.73 | 8.20 |
| RO [mol %] | 8.80 | 10.30 | 7.80 | 6.80 | 6.80 | 8.80 | 11.13 | 11.13 | 10.53 | 10.53 | 8.79 | 8.30 |
| Thermal expansion coefficient α | 55 | 53 | 52 | 52 | 55 | 49 | 54 | 54 | 49 | 52 | 51 | 42 |
| [×10⁻⁷° C.⁻¹] | | | | | | | | | | | | |
| Glass transition temperature | 637 | 619 | 633 | 635 | 626 | 652 | 602 | 613 | 623 | 608 | 600 | 649 |
| Tg [° C.] | | | | | | | | | | | | |
| Liquidus temperature T_{L} [° C.] | 1175 | 1167 | 1169 | 1176 | 1164 | 1138 | 1177 | 1182 | 1172 | 1162 | 1182 | 1138 |
| Surface compressive stress CS | 661 | 607 | 632 | 620 | 640 | 596 | 672 | 675 | 561 | 608 | 814 | 578 |
| [MPa] | | | | | | | | | | | | |
| Depth of compressive stress | 32 | 30 | 33 | 36 | 32 | 31 | 27 | 26 | 30 | 26 | 28 | 29 |
| layer DOL [μm] | | | | | | | | | | | | |
| T₄ − T_{L} [° C.] | | | | | | 85 | | | | | | |
| Melting temperature T_{2.5} [° C.] | | | | | | 1501 | | | | | | |
| Working temperature T₄ [° C.] | | | | | | 1223 | | | | | | |
| T_{4.5} [° C.] | | | | | | 1156 | | | | | | |
| Density (specific gravity) d | | | | | | 2.42 | | | | | | |
| [g · cm⁻³] | | | | | | | | | | | | |
| Young's modulus E [GPa] | | | | | | | | | | | | |

TABLE 3

| | | Examples | | | | | | | | | | | |
|---|---|---|---|---|---|---|---|---|---|---|---|---|---|
| | | 25 | 26 | 27 | 28 | 29 | 30 | 31 | 32 | 33 | 34 | 35 | 36 |
| Composition | SiO₂ | 64.1 | 64.0 | 63.1 | 63.1 | 63.4 | 63.4 | 63.6 | 63.2 | 63.8 | 61.6 | 64.1 | 66.1 |
| [mol %] | B₂O₃ | 4.70 | 3.70 | 4.70 | 4.70 | 4.70 | 4.70 | 4.70 | 4.70 | 4.70 | 4.70 | 4.70 | 4.70 |
| | Al₂O₃ | 14.60 | 14.60 | 14.60 | 14.60 | 14.60 | 14.60 | 14.60 | 14.60 | 13.60 | 12.60 | 10.60 | 10.60 |
| | MgO | 6.30 | 7.30 | 7.30 | 6.30 | 7.30 | 6.80 | 6.30 | 7.30 | 6.80 | 7.80 | 8.80 | 8.80 |
| | CaO | 2.00 | 1.80 | 1.50 | 2.50 | 1.50 | 2.00 | 2.00 | 1.50 | 2.00 | 2.00 | 2.00 | 2.00 |
| | SrO | 0 | 0 | 0 | 0 | 0 | 0 | 0 | 0 | 0 | 0 | 0 | 0 |
| | BaO | 0 | 0 | 0 | 0 | 0 | 0 | 0 | 0 | 0 | 0 | 0 | 0 |
| | ZnO | 0 | 0 | 0 | 0 | 0 | 0 | 0 | 0 | 0 | 2.00 | 0 | 0 |
| | Li₂O | 5.20 | 5.20 | 5.20 | 5.20 | 5.20 | 5.20 | 5.40 | 5.20 | 6.20 | 6.20 | 7.20 | 5.20 |
| | Na₂O | 0 | 0 | 0 | 0 | 0 | 0 | 0 | 0 | 0 | 0 | 0 | 0 |
| | K₂O | 3.00 | 3.30 | 3.50 | 3.50 | 3.20 | 3.20 | 3.30 | 3.40 | 2.80 | 3.00 | 2.50 | 2.50 |
| | TiO₂ | 0 | 0 | 0 | 0 | 0 | 0 | 0 | 0 | 0 | 0 | 0 | 0 |
| | ZrO₂ | 0 | 0 | 0 | 0 | 0 | 0 | 0 | 0 | 0 | 0 | 0 | 0 |
| | SnO₂ | 0.10 | 0.05 | 0.10 | 0 | 0.10 | 0 | 0.10 | 0.10 | 0 | 0.10 | 0.10 | 0 |

| | | | | | | | | | | | | |
|---|---|---|---|---|---|---|---|---|---|---|---|---|
| T-Fe₂O₃ [mass %] | 0.01 | 0.01 | 0.02 | 0.10 | 0.01 | 0.20 | 0.02 | 0.01 | 0.10 | 0.01 | 0.02 | 0.20 |
| R₂O [mol %] | 8.20 | 8.50 | 8.70 | 8.70 | 8.40 | 8.40 | 8.70 | 8.60 | 9.00 | 9.20 | 9.70 | 7.70 |
| RO [mol %] | 8.30 | 9.10 | 8.80 | 8.80 | 8.80 | 8.80 | 8.30 | 8.80 | 8.80 | 11.80 | 10.80 | 10.80 |
| Thermal expansion coefficient α | 45 | 52 | 51 | 54 | 51 | 50 | 52 | 52 | 53 | 53 | 53 | 48 |
| [×10⁻⁷° C.⁻¹] | | | | | | | | | | | | |
| Glass transition temperature | 647 | 653 | 643 | 642 | 643 | 647 | 650 | 647 | 629 | 606 | 587 | 622 |
| Tg [° C.] | | | | | | | | | | | | |
| Liquidus temperature T_{L} [° C.] | 1140 | 1152 | 1119 | 1123 | 1154 | 1138 | 1143 | 1128 | 1161 | 1115 | 1165 | 1160 |
| Surface compressive stress CS | 598 | 594 | 585 | 581 | 588 | 568 | 588 | 585 | 651 | 657 | 569 | 560 |
| [MPa] | | | | | | | | | | | | |
| Depth of compressive stress | 27 | 33 | 37 | 37 | 32 | 30 | 33 | 35 | 30 | 26 | 29 | 31 |
| layer DOL [μm] | | | | | | | | | | | | |
| T₄ − T_{L} [° C.] | | | | | | | | | | | | |
| Melting temperature T_{2.5} [° C.] | | | | | | | | | | | | |
| Working temperature T₄ [° C.] | | | | | | | | | | | | |
| T_{4.5} [° C.] | | | | | | | | | | | | |
| Density (specific gravity) d | | | | | | | | | | | | |
| [g · cm⁻³] | | | | | | | | | | | | |
| Young's modulus E [GPa] | | | | | | | | | | | | |

TABLE 4

| | | Examples | | | | | | |
|---|---|---|---|---|---|---|---|---|
| | | 37 | 38 | 39 | 40 | 41 | 42 | 43 |
| Composition | SiO₂ | 62.8 | 61.8 | 60.8 | 63.3 | 64.1 | 61.1 | 60.1 |
| [mol %] | B₂O₃ | 5.70 | 6.70 | 7.70 | 4.70 | 4.67 | 4.70 | 4.70 |
| | Al₂O₃ | 13.60 | 13.60 | 13.60 | 13.60 | 12.58 | 12.60 | 12.60 |
| | MgO | 7.30 | 7.30 | 7.30 | 7.30 | 5.87 | 8.80 | 9.80 |
| | CaO | 1.50 | 1.50 | 1.50 | 1.50 | 0 | 2.00 | 2.00 |
| | SrO | 0 | 0 | 0 | 0 | 2.92 | 0 | 0 |
| | BaO | 0 | 0 | 0 | 0 | 0 | 0 | 0 |
| | ZnO | 0 | 0 | 0 | 0 | 0 | 0 | 0 |
| | Li₂O | 6.20 | 6.20 | 6.20 | 6.20 | 7.20 | 7.20 | 7.20 |
| | Na₂O | 0 | 0 | 0 | 0 | 0 | 0 | 0 |
| | K₂O | 2.80 | 2.80 | 2.80 | 2.80 | 2.53 | 3.50 | 3.50 |
| | TiO₂ | 0 | 0 | 0 | 0 | 0 | 0 | 0 |
| | ZrO₂ | 0 | 0 | 0 | 0.50 | 0 | 0 | 0 |
| | SnO₂ | 0.10 | 0.05 | 0 | 0.10 | 0 | 0.10 | 0.10 |

| | | | | | | | |
|---|---|---|---|---|---|---|---|
| T-Fe₂O₃ [mass %] | 0.01 | 0.02 | 0.10 | 0.01 | 0.20 | 0.02 | 0.01 |
| R₂O [mol %] | 9.00 | 9.00 | 9.00 | 9.00 | 9.73 | 10.70 | 10.70 |
| RO [mol %] | 8.80 | 8.80 | 8.80 | 8.80 | 8.79 | 10.80 | 11.80 |
| Thermal expansion coefficient α | 55 | 53 | 53 | 52 | 52 | 57 | 59 |
| [×10⁻⁷° C.⁻¹] | | | | | | | |
| Glass transition temperature | 623 | 614 | 615 | 648 | 597 | 585 | 587 |
| Tg [° C.] | | | | | | | |
| Liquidus temperature T_{L} [° C.] | 1143 | 1126 | 1101 | 1154 | 1193 | 1150 | 1172 |
| Surface compressive stress CS | 620 | 590 | 593 | 635 | 794 | 711 | 715 |
| [MPa] | | | | | | | |
| Depth of compressive stress | 29 | 30 | 26 | 29 | 26 | 36 | 37 |
| layer DOL [μm] | | | | | | | |
| T₄ − T_{L} [° C.] | | | | | | | |
| Melting temperature T_{2.5} [° C.] | | | | | | | |
| Working temperature T₄ [° C.] | | | | | | | |
| T_{4.5} [° C.] | | | | | | | |
| Density (specific gravity) d | | | | | | | |
| [g · cm⁻³] | | | | | | | |
| Young's modulus E [GPa] | | | | | | | |

TABLE 5

| | | Comparative Examples | | | | | | | | | | | |
|---|---|---|---|---|---|---|---|---|---|---|---|---|---|
| | | 1 | 2 | 3 | 4 | 5 | 6 | 7 | 8 | 9 | 10 | 11 | 12 |
| Compo- | SiO₂ | 65.1 | 63.8 | 60.1 | 62.8 | 60.1 | 64.1 | 64.1 | 59.6 | 69.9 | 68.9 | 64.0 | 76.2 |
| sition | B₂O₃ | 4.67 | 4.70 | 4.70 | 4.70 | 4.70 | 0 | 0 | 4.70 | 3.00 | 0 | 10.82 | 12.15 |
| [mol %] | Al₂O₃ | 12.58 | 13.60 | 12.60 | 13.60 | 12.60 | 12.58 | 12.58 | 12.60 | 16.98 | 13.99 | 9.95 | 3.57 |
| | MgO | 8.79 | 7.30 | 8.80 | 7.30 | 8.80 | 8.79 | 8.79 | 6.80 | 4.00 | 9.99 | 8.88 | 0 |
| | CaO | 0 | 1.50 | 2.00 | 1.50 | 2.00 | 0 | 0 | 2.00 | 0 | 0 | 0 | 0.12 |
| | SrO | 0 | 0 | 0 | 0 | 0 | 0 | 0 | 0 | 0 | 0 | 0.17 | 0 |
| | BaO | 0 | 0 | 0 | 0 | 0 | 0 | 0 | 0 | 0 | 0 | 0 | 1.32 |
| | ZnO | 0 | 0 | 0 | 0 | 0 | 0 | 0 | 4.00 | 0 | 0 | 0 | 0 |
| | Li₂O | 7.20 | 6.20 | 7.20 | 6.20 | 7.20 | 11.87 | 9.92 | 7.20 | 5.00 | 4.00 | 3.61 | 0 |
| | Na₂O | 0 | 2.80 | 0 | 0 | 0 | 0 | 0 | 0 | 0 | 0 | 0 | 6.61 |
| | K₂O | 1.56 | 0 | 2.50 | 2.80 | 2.50 | 2.53 | 4.48 | 3.00 | 1.00 | 3.00 | 2.41 | 0 |
| | TiO₂ | 0 | 0 | 2.00 | 0 | 0 | 0 | 0 | 0 | 0 | 0 | 0 | 0 |
| | ZrO₂ | 0 | 0 | 0 | 1.00 | 2.00 | 0 | 0 | 0 | 0 | 0 | 0 | 0 |
| | SnO₂ | 0.10 | 0.10 | 0.10 | 0.10 | 0.10 | 0.10 | 0.10 | 0.10 | 0.10 | 0.10 | 0.09 | 0 |

| | | | | | | | | | | | | |
|---|---|---|---|---|---|---|---|---|---|---|---|---|
| T-Fe₂O₃ [mass %] | 0.02 | 0.02 | 0.01 | 0.01 | 0.02 | 0.02 | 0.01 | 0.01 | 0 | 0 | 0.04 | 0 |
| R₂O [mol %] | 8.76 | 9.00 | 9.70 | 9.00 | 9.70 | 14.40 | 14.40 | 10.20 | 6.00 | 7.00 | 6.02 | 6.61 |
| RO [mol %] | 8.79 | 8.80 | 10.80 | 8.80 | 10.80 | 8.79 | 8.79 | 12.80 | 4.00 | 9.99 | 9.05 | 1.44 |
| Thermal | 48 | 51 | 53 | 49 | 52 | 63 | 67 | 55 | 32.8 | 47.2 | 45 | |
| expansion | | | | | | | | | | | | |
| coefficient α | | | | | | | | | | | | |
| [×10⁻⁷° C.⁻¹] | | | | | | | | | | | | |
| Glass transition | | 627 | 597 | 632 | 617 | 601 | 606 | 582 | 716 | 725 | 617 | 565 |
| temperature | | | | | | | | | | | | |
| Tg [° C.] | | | | | | | | | | | | |
| Liquidus | | 1168 | 1138 | 1210< | 1210< | 1210< | 1210< | 1210< | 1210< | 1210< | 1058 | |
| temperature | | | | | | | | | | | | |
| T_{L} [° C.] | | | | | | | | | | | | |
| Surface | 619 | 839 | 692 | 649 | 759 | N/A | N/A | 851 | 524 | 420 | 290 | 375 |
| compressive | | | | | | | | | | | | |
| stress CS | | | | | | | | | | | | |
| [MPa] | | | | | | | | | | | | |
| Depth of | 17 | 14 | 23 | 27 | 20 | N/A | N/A | 25 | 11 | 30 | 42 | 17 |
| compressive | | | | | | | | | | | | |
| stress | | | | | | | | | | | | |
| layer DOL [μm] | | | | | | | | | | | | |
| T₄ − T_{L} [° C.] | | | | | | | | | | | | |
| Melting | | | | | | | | | | | | |
| temperature | | | | | | | | | | | | |
| T_{2.5} [° C.] | | | | | | | | | | | | |
| Working | | | | | | | | | | | | |
| temperature | | | | | | | | | | | | |
| T₄ [° C.] | | | | | | | | | | | | |
| T_{4.5} [° C.] | | | | | | | | | | | | |
| Density (specific | | | | | | | | | | | | |
| gravity) d | | | | | | | | | | | | |
| [g · cm⁻³] | | | | | | | | | | | | |
| Young's modulus | | | | | | | | | | | | |
| E [GPa] | | | | | | | | | | | | |

### INDUSTRIAL APPLICABILITY

The present invention can provide a glass composition suitable for production of glass sheets by a float process, for example, production of glass sheets for use as glass substrates for displays.

1. A glass composition comprising, in mol %:
58% or more and less than 70% SiO₂;
0 to 14% B₂O₃;
10 to 16% Al₂O₃;
0 to 12.5% MgO;
0 to 11% CaO;
0 to 3% SrO;
0 to 3% ZnO;
4.5 to 11% Li₂O;
0 to 2% Na₂O;
2 to 7% K₂O;
0 to 0.8% TiO₂;
0 to 0.5% ZrO₂; and
0 to 0.2% SnO₂, wherein
a total content of Li₂O, Na₂O, and K₂O is in a range of 6.5 to 13%.

2. The glass composition according to claim 1, comprising, in mol %:
60 to 69% SiO₂;
2 to 8% B₂O₃;
10 to 15% Al₂O₃;
1.5 to 11.5% MgO;
0 to 6% CaO;
0 to 2.5% SrO;
0 to 2.5% ZnO;
5 to 8% Li₂O; and
2 to 4% K₂O, wherein
the total content of Li₂O, Na₂O, and K₂O is in a range of 7 to 11%.

3. The glass composition according to claim 2, comprising, in mol %:
63 to 67% SiO₂;
3 to 6% B₂O₃;
12 to 15% Al₂O₃;
3 to 9% MgO;
0.5 to 1.5% CaO;
5 to 8% Li₂O;
2 to 3% K₂O;
0 to 0.15% TiO₂;
0 to 0.15% ZrO₂; and
0 to 0.1% SnO₂, wherein
the total content of Li₂O, Na₂O, and K₂O is in a range of 8 to 10%,
the glass composition is substantially free of SrO, ZnO, and Na₂O, and
the glass composition has a total iron oxide content (T-Fe₂O₃) of 0.2 mass % or less in terms of Fe₂O₃.

4. The glass composition according to claim 1, wherein an average thermal expansion coefficient is 60×10⁷° C.⁻¹ or less in a temperature range of 50 to 350° C.

5. The glass composition according to claim 4, wherein the average thermal expansion coefficient is 55×10⁷° C.⁻¹ or less in the temperature range of 50 to 350° C.

6. The glass composition according to claim 1, wherein a liquidus temperature T_{L} is 1200° C. or lower.

7. The glass composition according to claim 6, wherein a difference obtained by subtracting the liquidus temperature T_{L} from a temperature T₄ at which the glass composition has a viscosity of 10⁴ dPa·s is 0° C. or more.

8. A glass sheet for chemical strengthening, comprising the glass composition according to claim 1, wherein
the glass sheet is a glass sheet produced by a float process and used in chemical strengthening treatment.

9. A strengthened glass sheet comprising a compressive stress layer formed as a surface of the strengthened glass sheet by bringing the glass sheet according to claim 8 into contact with a molten salt containing monovalent cations having an ionic radius larger than that of sodium ions so as to cause ion exchange in which lithium ions and/or sodium ions contained in the glass composition are replaced by the monovalent cations.

10. The strengthened glass sheet according to claim 9, wherein the compressive stress layer has a surface compressive stress of 550 MPa or more and a depth of 25 μm or more.

11. The strengthened glass sheet according to claim 10, wherein the compressive stress layer has a surface compressive stress of 600 MPa or more and a depth of 30 μm or more.

12. A glass substrate for a display, the glass substrate comprising the strengthened glass sheet according to claim 10.

13. A glass substrate for a display, the glass substrate comprising the strengthened glass sheet according to claim 11.
